(19) United States
(12) Patent Application Publication
(10) Pub. No.: US 2015/0209958 A1
(43) Pub. Date: Jul. 30, 2015

(54) GEAR MECHANISM, SPEED CHANGE APPARATUS, ACTUATOR, AND ARTICULATED ROBOT ARM

(71) Applicant: CANON KABUSHIKI KAISHA, Tokyo (JP)

(72) Inventor: Masahide Hasegawa, Yokohama-shi (JP)

(21) Appl. No.: 14/600,267

(22) Filed: Jan. 20, 2015

(30) Foreign Application Priority Data
Jan. 29, 2014 (JP) 2014-014566

(51) Int. Cl. B25J 9/10; F16H 1/20

(52) U.S. Cl. CPC B25J 9/102; F16H 1/203

(57) ABSTRACT

A gear mechanism includes: a first gear; a second gear; an input shaft; a tilting shaft; an output shaft; a swing gear including: first teeth different in number by one tooth from teeth of the first gear; and second teeth different in number by one tooth from teeth of the second gear, the swing gear being configured to mesh with the first gear and the second gear at a certain tilting angle; and a coupling unit configured to couple the input shaft and the tilting shaft to each other so as to prevent relative rotation between the input shaft and the tilting shaft, and to allow the tilting shaft to freely swing about a center part between the first gear and the second gear in a plane including an input rotational axis.

### BACKGROUND OF THE INVENTION

1. Field of the Invention

The present invention relates to a gear mechanism using a swing gear mechanism, a speed change apparatus using the gear mechanism, an actuator using the speed change apparatus, and an articulated robot arm using the actuator on a joint thereof.

2. Description of the Related Art

In general, industrial robots employ a speed reduction apparatus to convert a high-speed and low-torque output of a drive motor into a low-speed and high-torque output, to thereby drive each of joints. A strain wave gear mechanism utilizing differential motion between an ellipsoidal gear and a circular gear is known as the speed reduction apparatus used for the industrial robots. The strain wave gear mechanism has a large number of teeth simultaneously meshing with each other, thereby being capable of providing a high torque capacity. Therefore, the strain wave gear mechanism is used for many industrial robots. However, the strain wave gear mechanism has such problems that the cost is high and durability is low due to the ulitization of deformation.

On the other hand, as the speed reduction apparatus, Japanese Patent Application Laid-Open No. 2011-163503 discloses a swing gear mechanism capable of providing a large speed reduction ratio through swing motion of a swing gear. This swing gear mechanism includes a freely rotatable input shaft, a tilting shaft integrated with the input shaft, a fixed gear provided coaxially with the input shaft, and a swing gear provided on the tilting shaft in a freely rotatable manner, different in the number of teeth from the fixed gear, and configured to obliquely mesh with the fixed gear. The swing gear is rotated in a tilted state through the rotation of the input shaft and the tilting shaft. As a result, the swing gear rotates (revolves) with respect to the fixed gear by an amount corresponding to a difference in the number of teeth per rotation of the input shaft. Therefore, the rotation of the input shaft is reduced in speed by extracting only this revolution component on the output shaft, and is output from the output shaft. Note that, face wheels are employed as the teeth of the fixed gear and the swing gear.

However, the swing gear mechanism described above employs the face wheels, thereby being difficult to increase the number of teeth meshing with each other between the swing gear and the fixed gear. Therefore, there arises such a problem that the swing gear mechanism is not suited to, for example, a speed reduction apparatus requiring a high rigidity and a high torque capacity, which is used as a joint actuator of the industrial robot. Moreover, in the swing gear mechanism described above, the input shaft and the tilting shaft are integrated with each other, and hence a high machining precision is required for the input shaft and the tilting shaft. Therefore, there arises such a problem that considerable man-hours are required, resulting in high cost.

### SUMMARY OF THE INVENTION

According to one embodiment of the present invention, there is provided a gear mechanism, including: a first gear including teeth directed toward one side in an axial direction, and being fixed to a casing; a second gear including teeth opposed to the teeth of the first gear, and being provided coaxially with the first gear; a first shaft provided coaxially with the first gear and the second gear in a freely rotatable manner; a tilting shaft provided so as to be tilted with respect to the first shaft; a first swing gear arranged between the first gear and the second gear, and provided so as to freely rotate about the tilting shaft, the first swing gear including: first teeth different in number by one tooth from the teeth of the first gear, and configured to mesh with the teeth of the first gear; and second teeth different in number by one tooth from the teeth of the second gear, and configured to mesh with the teeth of the second gear on an opposite side of a meshing portion of the first teeth with the teeth of the first gear in a radial direction and in the axial direction, the first swing gear being configured to mesh with the first gear and the second gear at a certain tilting angle; a second shaft provided coaxially with the first shaft, and configured to rotate integrally with any one of the second gear and the first swing gear; and a coupling unit configured to couple the first shaft and the tilting shaft to each other so as to prevent relative rotation between the first shaft and the tilting shaft, and to allow the tilting shaft to freely swing about a center part between the first gear and the second gear in a plane including a center axis of the first shaft.

Further features of the present invention will become apparent from the following description of exemplary embodiments with reference to the attached drawings.

### BRIEF DESCRIPTION OF THE DRAWINGS

FIG. 1 is a perspective view illustrating a schematic configuration of a robot apparatus according to a first embodiment of the present invention.

FIG. 2A is a vertical cross sectional view of a speed reduction apparatus according to the first embodiment of the present invention.

FIG. 2B is a side view of respective gears of the speed reduction apparatus according to the first embodiment of the present invention.

FIG. 2C is an exploded perspective view of the respective gears of the speed reduction apparatus according to the first embodiment of the present invention.

FIG. 2D is an exploded perspective view of an input shaft and a tilting shaft of the speed reduction apparatus according to the first embodiment of the present invention.

FIG. 2E is a vertical cross sectional view of the input shaft and the tilting shaft of the speed reduction apparatus according to the first embodiment of the present invention.

FIG. 3 is a diagram for acquiring a protruded tooth profile curve of a gear mechanism according to the first embodiment of the present invention.

FIG. 4A is a diagram illustrating a state in which tooth tip distal end portions are in contact with each other during meshing between a first gear and a swing gear.

FIG. 4B is a diagram illustrating a slightly advanced meshing state during the meshing between the first gear and the swing gear.

FIG. 4C is a diagram illustrating an approximately half meshing state during the meshing between the first gear and the swing gear.

FIG. 4D is a diagram illustrating a further advanced meshing state during the meshing between the first gear and the swing gear.

FIG. 4E is a diagram illustrating a state in which the tooth tip part and a recessed part mesh with each other during the meshing between the first gear and the swing gear.

FIG. 5A is a vertical cross sectional view of a speed reduction apparatus according to a second embodiment of the present invention.

FIG. 5B is an exploded perspective view of an input shaft and a tilting shaft of the speed reduction apparatus according to the second embodiment of the present invention.

FIG. 6A is a vertical cross sectional view of a speed reduction apparatus according to a third embodiment of the present invention.

FIG. 6B is an exploded perspective view of an input shaft and a tilting shaft of the speed reduction apparatus according to the third embodiment of the present invention.

FIG. 6C is an exploded perspective view of another input shaft and another tilting shaft of the speed reduction apparatus according to the third embodiment of the present invention.

FIG. 6D is a perspective view of another form of the input shaft and the tilting shaft of the speed reduction apparatus according to the third embodiment of the present invention.

FIG. 6E is a vertical cross sectional view of FIG. 6D.

FIG. 7A is a vertical cross sectional view of an actuator according to a fourth embodiment of the present invention.

FIG. 7B is a side view of respective gears on a radially outer side of the actuator according to the fourth embodiment of the present invention.

FIG. 7C is a side view of respective gears on a radially inner side of the actuator according to the fourth embodiment of the present invention.

### DESCRIPTION OF THE EMBODIMENTS

Preferred embodiments of the present invention will now be described in detail in accordance with the accompanying drawings.

### First Embodiment

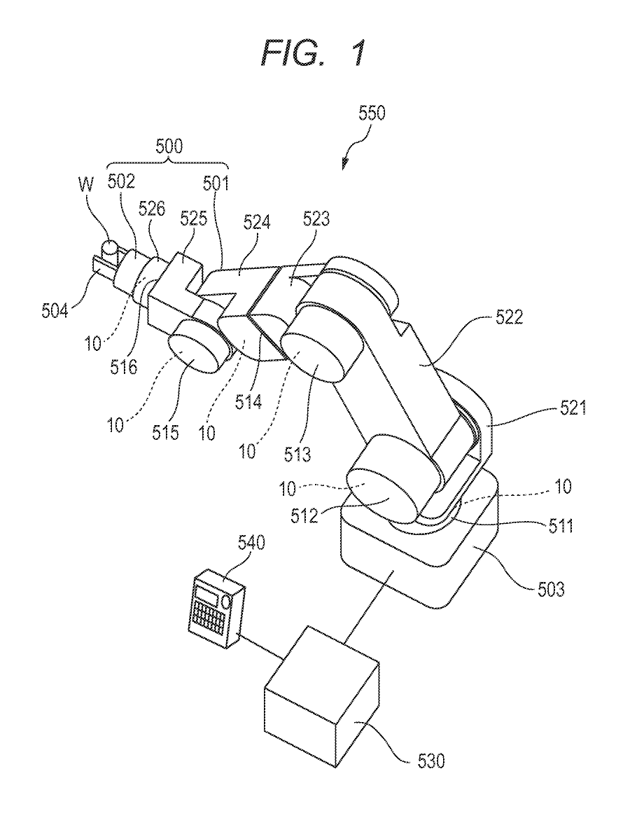

Referring to FIGS. 1 to 4E, a robot apparatus 550 according to a first embodiment of the present invention is now described. First, referring to FIG. 1, a schematic configuration of the robot apparatus 550 according to the first embodiment is described.

The robot apparatus 550 includes an articulated robot 500, which is an industrial robot for carrying out an operation such as an assembly of a workpiece W, a control device 530 for controlling the articulated robot 500, and a teaching pendant 540 connectable to the control device 530.

The articulated robot 500 includes a six-axis articulated robot arm (hereinafter referred to simply as robot arm) 501, and an end effector 502 connected to a distal end of the robot arm 501.

The robot arm 501 includes a base part 503 to be fixed to a work bench, a plurality of links 521 to 526 for transmitting displacement and a force, and a plurality of joints 511 to 516 for coupling the plurality of links 521 to 526 to each other for turn or rotation. Each of the plurality of joints 511 to 516 includes a drive motor (not shown), an encoder (not shown) for detecting a rotational angle of a rotational shaft of the drive motor, and a speed reduction apparatus (speed change apparatus) 10 for reducing an output of the drive motor in order to increase a torque of the drive motor. Note that, the drive motor and the speed reduction apparatus 10 construct an actuator, and the speed reduction apparatus 10 is detailed later.

The end effector 502 is a robot hand, and includes gripping claws 504 for gripping the workpiece W, a drive motor (not shown) for driving the gripping claws 504, an encoder (not shown) for detecting the rotational angle of the drive motor, and a speed reduction apparatus (not shown) for reducing an output of the drive motor. Moreover, the end effector 502 includes a force sensor (not shown) capable of detecting stresses (reaction forces) acting on the gripping claws 504 and the like.

The control device 530 is constructed by a computer to control the articulated robot 500. The computer constructing the control device 530 includes, for example, a CPU, a RAM for temporarily storing data, a ROM for storing programs for controlling respective parts, and an input/output interface circuit. The control device 530 controls the supply of required electric power required for the operation of the drive motor from a power supply main unit (not shown) to the drive motor, thereby moving positions and attitudes of the robot arm 501 and the end effector 502. The teaching pendant 540 can be connected to the control device 530, and can input an instruction when drive control is applied to the robot arm 501 and the end effector 502.

The robot apparatus 550 configured as described above moves or stops the end effector 502 to an arbitrary position and attitude through the control by the control device 530 for operations of the drive motors for a plurality of joints 511 to 516 of the robot arm 501 based on input settings and the like. Then, the robot apparatus 550 controls the end effector 502 to grip the workpiece W or other such parts while using the force sensor to detect the stresses acting on the gripping claws 104 at the arbitrary position and attitude, thereby carrying out an operation such as assembly of the workpiece W.

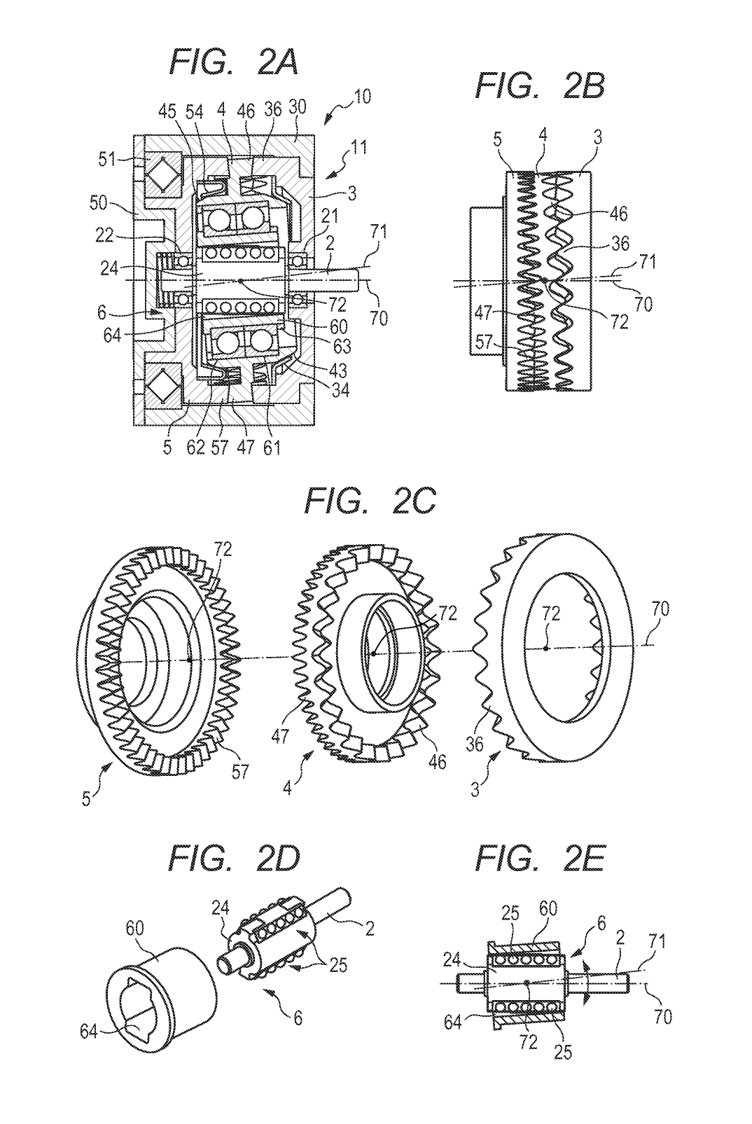

Referring to FIGS. 2A to 4E, the speed reduction apparatus 10 according to the first embodiment is now described. First, referring to FIGS. 2A to 2E, a schematic configuration of the speed reduction apparatus 10 is described. Note that, a case in which the speed change apparatus according to the present invention is applied to the speed reduction apparatus 10 is described in this embodiment, but the application is not limited to this case, and the speed change apparatus may be applied to a speed increase apparatus.

As illustrated in FIGS. 2A to 2C, the speed reduction apparatus 10 includes one unit of a gear mechanism 11, and the gear mechanism 11 includes a first gear 3, a second gear 5, an input shaft 2, a tilting shaft 60, a swing gear (first swing gear) 4, an output shaft 50, and a coupling unit 6. The input shaft (first shaft, one shaft) 2 is connected to the drive motor, and is provided coaxially with the first gear 3 and the second gear 5 so as to freely rotate through intermediation of bearings 21 and constructed by rolling bearings, for example. The output shaft (second shaft, the other shaft) 50 is connected to the plurality of links 521 to 526, and is pivotally supported on the casing 30 through intemediation of a bearing 51 constructed by, for example, a rolling bearing, so as to be coaxial with the input shaft 2. Further, the output shaft 50 is configured to rotate integrally with any one of the second gear 5 and the swing gear 4, and, according to this embodiment, is configured to rotate integrally with the second gear 5. Each speed reduction apparatus 10 reduces the rotation input from the drive motor, and transmits the resultant to each of the plurality of links 521 to 526. In other words, the speed reduction apparatus 10 includes at least one unit of the gear mechanism 11, and is configured to reduce the rotation input to the input shaft 2 and output the resultant from the output shaft 50.

The first gear 3 includes teeth 36 directed toward one side in the axial direction, and is fixed to the casing 30. The number of the teeth 36 is Z1. The teeth 36 include a plurality of tooth tip parts formed on a distal end side with respect to a predetermined height and a plurality of recessed parts each formed between the tooth tip parts on a tooth base side with respect to the predetermined height, and are formed into an annular profile. The second gear 5 includes teeth 57 opposed to the first gear 3. The second gear 5 is provided coaxially with the first gear 3, and is fixed to the output shaft 50. The number of the teeth 57 is Z2. The teeth 57 include a plurality of tooth tip parts formed on a distal end side with respect to a predetermined height and a plurality of recessed parts each formed between the tooth tip parts on a tooth base side with respect to the predetermined height, and are formed into an annular profile.

The swing gear 4 is arranged between the first gear 3 and the second gear 5, and is provided so as to freely rotate about the tilting shaft 60. The swing gear 4 includes first teeth 46 for meshing with the teeth 36 of the first gear 3 and second teeth 47 for meshing with the teeth 57 of the second gear 5, and tooth surfaces are formed into annular profiles on both surfaces. The number of the first teeth 46 is Z1+1 (different by one from the number of teeth of the first gear 3). The number of the second teeth 47 is Z2+1 (different by one from the number of teeth of the second gear 5). The second teeth 47 are configured to mesh with the second gear 5 on a side opposite to a meshing portion of the first teeth 46 with the teeth 36 of the first gear 3 in the radial direction and the axial direction. As a result, the swing gear 4 is configured to mesh with the first gear 3 and the second gear 5 at a certain tilting angle.

The swing gear 4 includes tooth tip parts formed on a distal end side with respect to a predetermined height, recessed parts each formed between the tooth tip parts on a tooth base side with respect to the predetermined height, which are larger in number than the first gear 3 and the second gear 5, and the tooth surfaces formed into the annular profiles. Under the state in which the swing gear 4 meshes with the first gear 3 and the second gear 5 at the predetermined tilting angle, the swing gear 4 is pivotally supported on the tilting shaft 60 having the tilting direction regulated by the input shaft 2 in a freely rotatable manner through intemediation of the bearings 61 and 62. Each of the bearings 61 and 62 is constructed, for example, by a rolling bearing, and is mounted to the tilting shaft 60 by a stopper 63 in an annular profile. Note that, as illustrated in FIGS. 2D and 2E, a rectangular hole 64, which is axially bored, is formed in the tilting shaft 60, and the input shaft 2 is pivotally supported by the rectangular hole 64 through intemediation of linear motion bearings 25.

As illustrated in FIGS. 2B and 2C, the teeth 36 of the first gear 3 and the first teeth 46 of the swing gear 4 are arranged in a state tilted by a predetermined angle. As a result, the teeth 36 and the first teeth 46 are configured to be able to form a most deeply meshing position at which the tooth tip part and the recessed part most deeply mesh with each other, and a passing-by position which is on an opposite side to the most deeply meshing position, and at which the tooth tip parts pass by each other. Further, the teeth 36 and the first teeth 46 are arranged to be tilted at the predetermined angle so as to be able to form, on both sides of the passing-by position, first meshing areas where the tooth tip parts are brought into contact with each other and second meshing areas where the tooth tip part and the recessed part are brought into contact with each other on a side closer to the most deeply meshing position than the first meshing areas.

Similarly, the teeth 57 of the second gear 5 and the second teeth 47 of the swing gear 4 are arranged in a state tilted by a predetermined angle so as to be able to form a most deeply meshing position at which the tooth tip part and the recessed part most deeply mesh with each other, and a passing-by position which is on an opposite side to the most deeply meshing position, and at which the tooth tip parts pass by each other. Further, the teeth 57 and the second teeth 47 are arranged to be tilted at the predetermined angle so as to be able to form, on both sides of the passing-by position, first meshing areas where the tooth tip parts are brought into contact with each other and second meshing areas where the tooth tip part and the recessed part are brought into contact with each other on a side closer to the most deeply meshing position than the first meshing areas.

Specifically, the teeth 36 of the first gear 3 and the first teeth 46 of the swing gear 4 are arranged so as to shift in phase from each other by half a pitch. At a reference phase (most deeply meshing position) on the lower side of the drawing sheet of FIG. 2B, the tooth 36 of the first gear 3 and the first tooth 46 of the swing gear 4 shift in phase from each other by half a pitch, and deeply mesh with each other. Moreover, in the vicinity of positions of ±90 degrees with respect to the reference phase, which are on the front side of FIG. 2B (positions at boundaries between the first meshing areas and the second meshing areas), the tooth 36 and the first tooth 46 shift in phase from each other by ¼ pitch, and shallowly mesh with each other (for example, the tooth tip parts are in contact with each other at a single point).

Further, at positions of ±180 degrees (passing-by position) with respect to the reference phase, which are on the upper side of the drawing sheet of FIG. 2B, the tooth 36 of the first gear 3 and the first tooth 46 of the swing gear 4 are in the same phase, and the distal ends of the tooth tip parts are in contact with each other. Then, the teeth 36 and the first teeth 46 are configured to gradually change the phase to change the meshing depth, resulting in contacts between the teeth 36 of the first gear 3 and the first teeth 46 of the swing gear 4 over substantially the entire circumference between these phases. Similarly, the teeth 57 of the second gear 5 and the second teeth 47 of the swing gear 4 are configured to gradually change the phase to change the meshing depth, resulting in contacts between the teeth 57 and the second teeth 47 over substantially the entire circumference. Note that, the teeth 57 of the second gear 5 and the teeth 36 of the first gear 3 may be different in number.

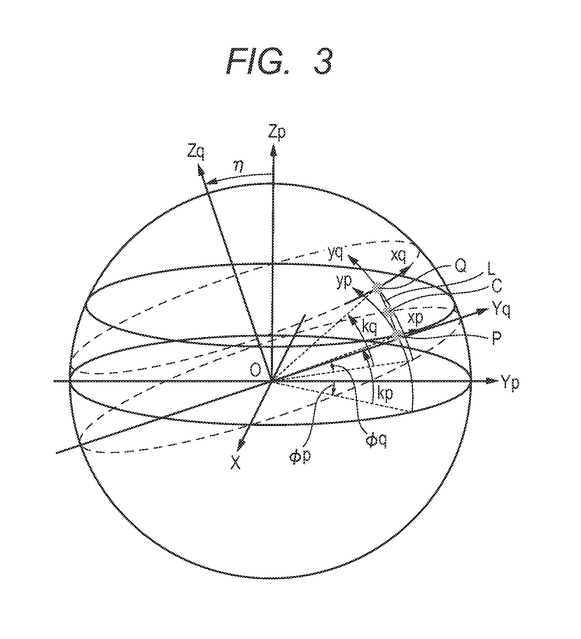

Referring to FIG. 3, such a principle that the teeth 36 of the first gear 3 and the first teeth 46 of the swing gear 4 are brought into contact with each other over substantially the entire circumference of the gears, and the teeth 57 of the second gear 5 and the second teeth 47 of the swing gear 4 are brought into contact with each other over substantially the entire circumference of the gears is now described.

As illustrated in FIG. 3, an input rotational axis (center axis) 70 of the first gear 3 is denoted by Zp axis; a tilting rotational axis 71 of the swing gear 4, Zq axis; a tilting angle of the Zq axis with respect to the Zp axis, n; and a reference point 72 as an intersection of the tilting rotational axis 71 and the input rotational axis 70, origin O. Moreover, a common axis in a direction orthogonal to a plane containing the Zp axis and the Zq axis is the X axis. Then, an XYpZp coordinate system and an XYqZq coordinate system are set. A spherical surface centered at the origin O and having a radius R is now considered.

Next, points P and Q (each referred to as reference point of teeth) moving clockwise at constant speeds from the Yp axis direction and the Yq axis direction on small circles (referred to as reference pitch circles) at latitude offsets kp and kq with respect to an XYp plane and an XYq plane, which are equatorial planes of the respective coordinate systems, are considered. If the number of the teeth 36 of the first gear 3 is Z1, and the number of the first teeth 46 of the swing gear 4 is Z1+1, latitudes of the points P and Q are represented as φp=2nt/Z1 and φq=2nt/(Z1+1) (t: parameter).

On this occasion, a point C on an arc L of a great circle connecting the points P and Q with each other is set to a meshing point, and trajectories of the point C in moving coordinate systems xpyp and xqyq on spheres having the points P and Q as origins are to be acquired. The trajectories can be used as protruded profiles of the tooth tip parts, thereby bringing the tooth tips successively in contact with each other in a range of approximately ±90° from the passing-by phase. The trajectory is a curve close to the COS function, but is complex and cannot be represented by a simple equation. The coordinate of the point C is acquired, to thereby acquire differences from the coordinates of the points P and Q.

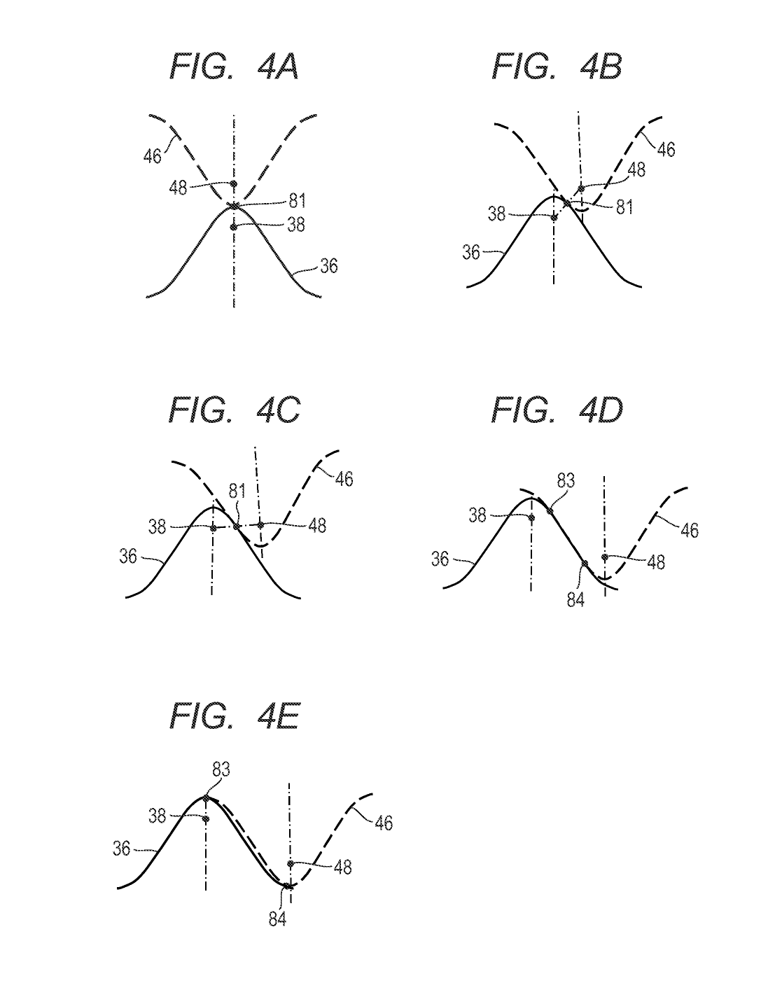

Referring to FIGS. 4A to 4E, such a principle that the tooth tip parts of the teeth 36 of the first gear 3 and the recessed parts of the first teeth 46 of the swing gear 4 are brought into contact with each other, and the recessed parts of the teeth 36 of the first gear 3 and the tooth tip parts of the first teeth 46 of the swing gear 4 are brought into contact with each other is now described.

The profiles of the tooth tip parts of the teeth 36 of the first gear 3 and the first teeth 46 of the swing gear 4 are formed as described before. With this, as illustrated in FIG. 4A, at the phase (passing-by position) in the Yp and Yq directions, the distal ends of the tooth tip parts at predetermined heights from reference points (predetermined heights) 38 and 48 are brought into contact with each other at a meshing point 81. Then, as the position turns toward the X axis direction on the both sides of the passing-by position, as illustrated in FIGS. 4B and 4C, the meshing point 81 transitions in the first meshing areas (the tooth tip parts are in contact with each other at a single point). Although a profile of the tooth tip part formed up to a vicinity of the boundary position in the X axis direction is a protruded profile, interference occurs if the recessed part on the tooth base side with respect to the protruded profile is formed into a tooth profile based on the trajectory of the point C described above. Thus, in this embodiment, the meshing point 81 in the vicinity of the boundary position is considered as a meshing reference point (reference position). Then, the tooth profile curve of the recessed part on the tooth base side with respect to the meshing reference point is formed as a curve acquired as a circumscribed line (recessed profile aligned with a passed area) of such a trajectory that the tooth tip part on the distal end side with respect to the meshing reference point moves at the tooth base part of the mating tooth.

Therefore, as illustrated in FIGS. 4D and 4E, the tooth tip part of the tooth and the recessed part of the mating tooth mesh with each other in the second meshing area, and meshing thus occurs simultaneously at two points represented by contact points 83 and 84.

The first gear 3 and the swing gear 4 of the gear mechanism according to this embodiment are thus brought into contact with each other over substantially the entire circumference in this way. A transmitted torque is thus shared, and an extremely large load capacity can be provided by the compact and light-weight gear mechanism. Moreover, the pressure angle decreases as the number of teeth Z increases and as the tilting angle n increases, and an appropriate pressure angle can thus be set. Further, as illustrated in FIGS. 4A to 4E, a curve of the tooth profile before and after the meshing reference point is close to a straight line. Particularly, the tooth tip part and the recessed part mesh with each other at two points and between the protruded surface and the recessed surface at a phase at which the meshing is deeper than the meshing reference point. Therefore, the contact pressure is reduced. Thus, the tooth profile can be formed so that the tooth surface stress is low and the tooth is less worn.

Note that, the same actions and effects can be obtained for the teeth 57 of the second gear 5 and the second teeth 47 of the swing gear 4 though only the numbers of teeth are different. A detailed description thereof is therefore omitted.

The teeth 36 of the first gear 3, the first teeth 46 of the swing gear 4, the teeth 57 of the second gear 5, and the second teeth 47 of the swing gear 4 are formed into such a tooth profile as to come in contact with each other over substantially the entire circumference in this way. Thus, out of degrees of freedom in the attitude of the swing gear 4, degrees of freedom other than the tilting direction are regulated by the meshing between the teeth. In other words, the position is regulated by the shared reference point 72, and the tilting angle of the tilting rotational axis 71 and the rotational phase about the axis are regulated by the meshing between the teeth.

Further, according to this embodiment, preloads are applied so as to minimize a backlash between the first gear 3 and the swing gear 4 and a backlash between the second gear 5 and the swing gear 4. For this purpose, as illustrated in FIG. 2A, a plate spring (support unit) 34 is provided for the first gear 3 and a plate spring (support unit) 54 is provided for the second gear 5. Then, the preload is applied through a contact between an inner conical surface of the plate spring 34 fixed to the first gear 3 and an annular surface (contact surface) 43 provided on the swing gear 4. Moreover, the preload is applied through a contact between an inner conical surface of the plate spring 54 fixed to the second gear 5 and an annular surface (contact surface) 45 provided on the swing gear 4.

The plate spring 34 and the annular surface 43, and the plate spring 54 and the annular surface 45 are shaped so as to be brought into contact with each other only at the upper and lower phases in FIG. 2A, respectively, and a ratio between the radii of the contact parts with respect to the input rotational axis 70 and the tilting rotational axis 71 is set to a ratio of reciprocals of the numbers of teeth. Specifically, both of the contact surfaces of the plate spring 34 and the annular surface 43 and the contact surfaces of the plate spring 54 and the annular surface 45 are shaped so that the contacts occur at the portions without relative speed. In other words, the speed of the inner conical surface of the plate spring 34 can be acquired by multiplying a distance (radius) between the inner conical surface of the plate spring 34 and the input rotational axis 70, which is the center axis of the inner conical surface, by the rotational speed of the first gear 3. Moreover, the speed of the annular surface 43 of the swing gear 4 can be acquired by multiplying a distance (radius) between the annular surface 43 of the swing gear 4 and the tilting rotational axis 71, which is the center axis of the annular surface 43, by the rotational speed of the swing gear 4. The contact surfaces can be shaped so that the contact can occur at the portions without relative speed by setting the respective radii so that the speed of the inner conical surface of the plate spring 34 and the speed of the annular surface 43 of the swing gear 4 match each other. Note that, the same holds true for the plate spring 54 and the annular surface 45.

As illustrated in FIGS. 2A and 2B, resultant forces of forces acting on the plate spring 34 and the annular surface 43 and forces acting on tooth surfaces of the first gear 3 and the swing gear 4 are opposite directions and thus cancel each other in an up/down direction, resulting in a force pushing the swing gear 4 toward the left direction. Moreover, resultant forces of forces acting on the plate spring 54 and the annular surface 45 and forces acting on tooth surfaces of the first gear 3 and the swing gear 4 similarly result in a force pushing the swing gear 4 toward the right direction. Thus, a load caused by the axial preload force is generated on the bearing 51, but a load caused by the moment force can be suppressed to be small, and a load torque and a vibration do not increase. Moreover, as described before, the ratio between the radii of the contact parts with respect to the input rotational axis 70 and the tilting rotational axis 71 is set to the ratio of reciprocals of the numbers of teeth, and the momentary tangential velocities of the contact parts are thus equal to each other, which represents a rolling contact state. As a result, a configuration capable of suppressing an increase in the load torque and the wear caused by the preload force to minimum is provided.

On the other hand, as illustrated in FIGS. 2D and 2E, the tilting shaft 60 is provided so as to be tilted with respect to the input shaft 2. At a position between the tilting shaft 60 and the input shaft 2, the coupling unit 6 is provided for coupling the input shaft 2 and the tilting shaft 60 to each other so as to prevent relative rotation between the input shaft 2 and the tilting shaft 60, and to allow the tilting shaft 60 to freely swing about a center part (about a reference point 72) between the first gear 3 and the second gear 5 in a plane including the input rotational axis 70 of the input shaft 2. The tilting direction of the tilting shaft 60 is not regulated by the meshing between the teeth, but by the input shaft 2.

According to this embodiment, the coupling unit 6 includes a large diameter part (rotation restriction part) 24 provided on the input shaft 2 and a rectangular hole (support hole) 64 formed so as to pass through the tilting shaft 60 in the axial direction. On the input shaft 2, the large diameter part 24 is provided between small diameter parts fitted to the bearings 21 and 22, and four straight race surfaces are provided thereon. Two linear motion bearings 25 each including a plurality of steel balls and a retainer are mounted to the race surfaces. The fitting of the large diameter part 24 into the rectangular hole 64 formed in the tilting shaft 60 regulates, out of attitudes of the tilting shaft 60, a vertical position in the drawing sheet and a tilt occurring out of the plane, but does regulate a position and a tilt (represented by the arrow) in the drawing sheet. On this occasion, the drawing sheet is a plane including the axes 70 and 71, and is hereinafter referred to as tilting direction plane (one plane containing the center axes). In other words, as illustrated in FIG. 2E, as a result of fitting the tilting shaft 60 tilted by the predetermined angle into the input shaft 2, the tilting direction plane of the tilting shaft is regulated by the input shaft 2. As a result, the linear motion bearings 25 are configured to restrict the relative rotation about the axial direction between the input shaft 2 passing through the rectangular hole 64 and the tilting shaft 60 while permitting swing about a direction orthogonal to the axial direction.

On this occasion, as illustrated in FIG. 2A, the swing gear 4 is pivotally supported by the tilting shaft 60 through intemediation of the bearings 61 and 62, and, when the input shaft 2 is rotated so as to rotate the tilting direction plane of the tilting shaft 60, the tilting direction of the swing gear 4 is also rotated about the input rotational axis 70. In this way, the swing gear 4 is not regulated by the input shaft 2 in the position in the directions of the axes 70 and 71, the tilting angle, and the rotation about the tilting rotational axis 71, but is regulated only in the tilting direction. In other words, the relative motion between the linear motion bearings 25 and the rectangular hole 64 of the tilting shaft 60 can eliminate a high-precision machining and an unnecessary force generated by a mutual difference in the axial position between the tilting angle and the tilt reference point. Thus, machining of a tilting surface of the tilting shaft 60 is no longer necessary, and high precision machining and measurement become easy in terms of concentricity, parallelism, fit dimensions, and the like.

Moreover, the input shaft 2 is regulated in the axial position only by the bearings 21 and 22, and the bearings 21 and 22 do not receive a force from the swing gear 4. Thus, bearings small in the diameter not only easy in the assembly but also small in loss torque can be used, resulting in an improvement in efficiency. Note that, the rectangular hole 64 of the tilting shaft 60 swings with respect to the linear motion bearings 25 only mainly during an initial assembly, and slightly swings when the tilting angle of the swing gear 4 is changed by an influence of an error in the tooth surfaces, deformations of respective components by an external force, and the like. Moreover, the input shaft 2 is arranged on a high-speed shaft side in the speed reduction apparatus 10, and does thus not receive a large external force. Thus, bearings relatively low in rigidity are sufficient as the bearings 20 and 21, and an increase in size can be suppressed. The example of a cylindrical groove is described as the race surface, but because a slide is generated by a change in the tilting angle, it should be understood that a rolling contact may be realized also for the change in the tilting angle by providing a flat part in a ball contact part.

Referring to FIG. 2A, a speed reduction operation to be carried out by the speed reduction apparatus 10 including the above-mentioned gear mechanism 11 is now described.

When the input shaft 2 rotates by one turn, the tilting shaft 60 rotates about the input rotational axis 70, and the swing gear 4 carries out the swing motion once about the reference point 72, which is the intersection between the tilting rotational axis 71 and the input rotational axis 70. On this occasion, the swing gear 4 revolves by an angle corresponding to the difference in the number of teeth between the first gear 3 and the swing gear 4. In other words, when the input shaft 2 rotates by Z+1 turns, the swing gear 4 revolves by one turn. On the other hand, a revolution is generated through the swing between the second gear 5 and the swing gear 4. As a result, a rotational force input from the input shaft 2 is reduced in speed by the swing gear 4, and is output from the output shaft 50.

According to this embodiment, the first teeth 46 of the swing gear 4 are set to be larger in number by one tooth than the teeth 36 of the first gear 3, and the second teeth 47 of the swing gear 4 are set to be larger in number by one tooth than the teeth 57 of the second gear 5. Therefore, the first gear 3 and the second gear 5 rotate in directions opposite to each other about the swing gear 4 in the speed reduction apparatus 10. It is known that the speed reduction ratio of this speed reduction apparatus 10 can be calculated as 1−(Z1(Z2+1))/((Z1+1)Z2). For example, when Z1=24 and Z2=48, a speed reduction ratio of 1/50 is provided. Moreover, for example, when Z1=48 and Z2=49, a large speed reduction ratio of 1/2,401 can be provided. This speed reduction apparatus 10 can thus realize a wide range of the speed reduction ratio starting from a small speed reduction ratio of approximately 1/20 to a large speed reduction ratio of one few thousandths through the setting of the tooth numbers by using the simple gear mechanism 11. Moreover, the speed reduction apparatus 10 can be treated as a single-stage differential speed reduction apparatus.

As described above, in the speed reduction apparatus 10 according to this embodiment, the tilting angle and the axial position of the swing gear 4 are regulated by the two gears, which are the first gear 3 and the second gear 5, and the tilting direction is regulated by the tilting shaft 60. Therefore, the input shaft 2 and the tilting shaft 60 do not need to be integrated with each other, and component machining can be simplified compared with the case of integration. Moreover, the load torque can be shared among the large number of teeth, and hence a high assembly property, a high load capacity, a high rigidity, and a low loss can be realized without increasing the size.

Moreover, in the speed reduction apparatus 10 according to this embodiment, the swing gear 4 is supported in the radial direction by the plate springs 34 and 54 with respect to the first gear 3 and the second gear 4. As a result, a bearing load is reduced particularly when a high load torque is applied, and hence the load capacity and the rigidity can further be increased.

Moreover, in the speed reduction apparatus 10 according to this embodiment, the contact surfaces between the swing gear 4 and the plate springs 34 and 54 are shaped so that the contacts occur at the portions without relative speed, and hence the contacts at the contact surfaces can be rolling contacts. As a result, the load capacity and the rigidity can further be increased compared with a case of the sliding contact.

### Second Embodiment

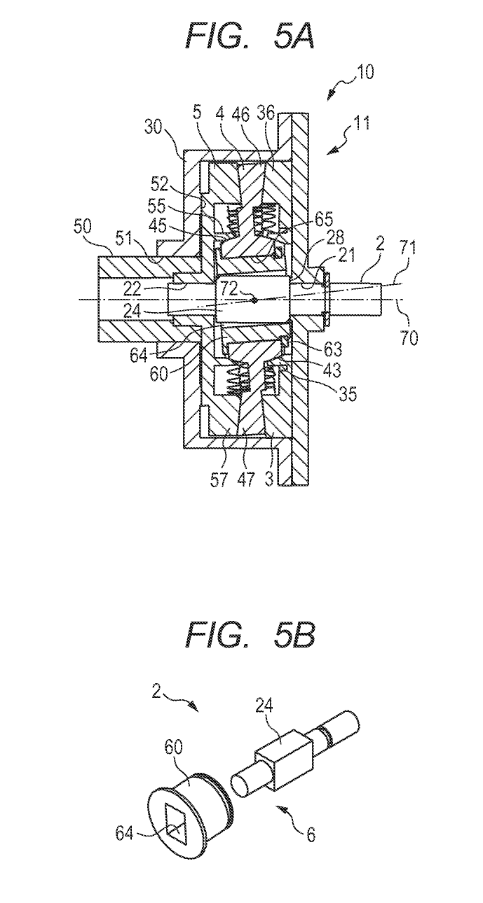

Referring to FIGS. 5A and 5B as well as FIG. 1, a robot apparatus 550 according to a second embodiment of the present invention is now described. The robot apparatus 550 according to the second embodiment is different from the first embodiment in the configuration of the speed reduction apparatus 10. Therefore, in the second embodiment, the speed reduction apparatus 10 different from the first embodiment is mainly described, and the same components as those of the first embodiment are denoted by the same reference symbols to omit a description thereof.

Referring to FIGS. 5A and 5B, the speed reduction apparatus 10 according to the second embodiment is now described. As illustrated in FIG. 5A, the speed reduction apparatus 10 according to this embodiment is different from the first embodiment in that the rolling bearings are replaced by slide bearings and that the differential speed reduction apparatus is a two-stage speed reduction apparatus.

In respect of the bearings, all of the bearings 21, 22, and 28 for the input shaft 2, the bearing 65 for the tilting shaft 60, and the bearings 51 and 52 for the output shaft 50 are constructed not by rolling bearings, but by radial or thrust slide bearings. As a result, the loss torque can be reduced, and simultaneously, the number of the components can be reduced, thereby reducing the size and the cost.

Moreover, both the numbers of the first teeth 46 and the second teeth 47 of the swing gear 4 are set to Z1, the number of teeth of the first gear 3 is set to Z1−1, and the number of teeth of the second gear 5 is set to Z1+1. The swing gear 4, the first gear 3, and the second gear 5 mesh with each other at a predetermined angle about the reference point 72. As in the first embodiment, the first teeth 46 and the second teeth 47 of the swing gear 4 have such tooth profiles as to come into contact respectively with the teeth 36 of the first gear 3 and the teeth 57 of the second gear 5 over substantially the entire circumference. Therefore, the tilting angle and the axial position of the swing gear 4 are regulated under the state in which the swing gear 4 is sandwiched between the first gear 3 and the second gear 5.

At a position between the tilting shaft 60 and the input shaft 2, the coupling unit 6 is provided for coupling the input shaft 2 and the tilting shaft 60 to each other so as to prevent relative rotation between the input shaft 2 and the tilting shaft 60, and to allow the tilting shaft 60 to freely swing about the center part between the first gear 3 and the second gear 5 in the plane including the input rotational axis 70 of the input shaft 2. The tilting direction of the tilting shaft 60 is not regulated by the meshing between teeth, but by the input shaft 2.

According to this embodiment, as illustrated in FIG. 5B, the coupling unit 6 includes the large diameter part (rotation restriction part) 24 having a rectangular pillar profile and provided on the input shaft 2 and the rectangular hole (support hole) 64 formed so as to pass through the tilting shaft 60 in the axial direction. The fitting of the large diameter part 24 into the rectangular hole 64 does not regulate the axial position due to the slide, but regulates only the tilting angle. According to this embodiment, the coupling unit 6 also forms a sliding pair in this way. Thus, an error in the tooth profile and small changes in the tilting angle and the axial position caused by deformations of the respective components are absorbed so as not to influence the input shaft 2.

Referring to FIG. 5A, a speed reduction operation to be carried out by the speed reduction apparatus 10 including the above-mentioned gear mechanism 11 is now described.

When the input shaft 2 rotates by one turn, the tilting shaft 60 rotates about the input rotational axis 70, and the swing gear 4 carries out the swing motion once about the reference point 72, which is the intersection between the tilting rotational axis 71 and the input rotational axis 70. On this occasion, the swing gear 4 revolves by an angle corresponding to the difference in the number of teeth between the first gear 3 and the swing gear 4. On the other hand, a revolution is generated through the swing also between the second gear 5 and the swing gear 4, and the angle thereof corresponds to the difference in the number of teeth between the second gear 5 and the swing gear 4. In this speed reduction apparatus 10, the first gear 3 and the second gear 5 rotate in the same direction, which is different from the first embodiment, about the swing gear 4. In other words, the configuration of the speed reduction apparatus 10 is such a configuration that differential gear mechanisms are serially connected to each other as two stages. It is known that the speed reduction ratio of this speed reduction apparatus 10 can be calculated as 2/(Z1+1). For example, when Z1=49, a speed reduction ratio of 1/25 is provided. Thus, this speed reduction apparatus 10 is suitable for an application for a relatively low speed reduction ratio.

On this occasion, as illustrated in FIG. 5A, when a load torque in the clockwise direction seen from the left side of the drawing sheet acts on the second gear 5, such a force that the teeth 57 on the near side of the drawing sheet push downward the second teeth 47 of the swing gear 4 acts. Simultaneously, the first teeth 46 of the swing gear on the far side of the drawing sheet push upward the teeth 36 of the first gear 3. Thus, the swing gear 4 receives the downward forces both from the first gear 3 and the second gear 5.

Thus, according to this embodiment, a reception part (support unit) 35 having a cylindrical profile is provided on the first gear 3, and a reception part (support unit) 55 having a cylindrical profile is provided on the second gear 5. Then, the downward force is supported through abutment of the annular surfaces 43 and 45 of the swing gear 4 against inner peripheral surfaces of these reception parts 35 and 55, thereby permitting only applications of the axial pressing forces from the first gear 3 and the second gear 5. As a result, the downward forces do not act on the input shaft 2, and the forces pushing the first gear 3 and the second gear 5 can be received by the bearings 51 and 52 on the output shaft 50 side.

Moreover, radius ratios in a pressed phase (lower direction of the drawing sheet) between the reception part and the annular surface 43 and between the reception part 55 and the annular surface 45 are set to ratios of the reciprocals of the numbers of teeth as in the first embodiment, and the momentary tangential velocities are thus equal, resulting in substantially rolling contacts. Note that, even if the radius ratio is set slightly different from the ratio of the reciprocals of the numbers of teeth in order to reduce the size and weight, the relative slide speed is low, and hence a practical use is possible.

As described above, in the speed reduction apparatus 10 according to this embodiment, in addition to the effects of the first embodiment, because not the rolling bearings but the slide bearings are used as the bearings, the loss torques can be reduced, and the number of components can be reduced, resulting in the reduction in size and cost.

### Third Embodiment

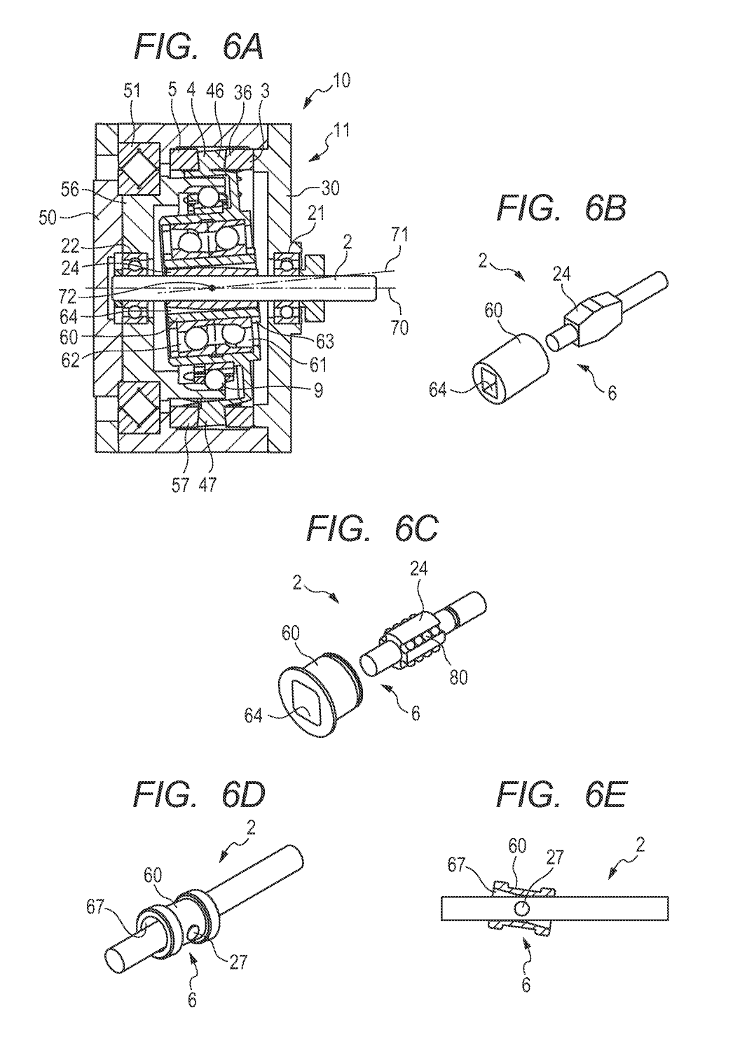

Referring to FIGS. 6A to 6E as well as FIG. 1, a robot apparatus 550 according to a third embodiment of the present invention is now described. The robot apparatus 550 according to the third embodiment is different from the first embodiment in the configuration of the speed reduction apparatus 10. Therefore, in the third embodiment, the speed reduction apparatus 10 different from the first embodiment is mainly described, and the same components as those of the first embodiment are denoted by the same reference symbols to omit a description thereof.

Referring to FIGS. 6A to 6E, the speed reduction apparatus 10 according to the third embodiment is now described. As illustrated in FIG. 6A, the speed reduction apparatus 10 according to this embodiment is different from the first embodiment in that the output shaft 50 is coupled to the swing gear 4, that the second gear 5 is fixed to the casing 30, and that the first gear 3 and the second gear 5 are equal in number of teeth.

According to this embodiment, the numbers of the teeth of the first gear 3 and the second gear 5 are set to Z1, and the numbers of the first teeth 46 and the second teeth 47 of the swing gear 4 are set to Z1+1. The profiles of the respective teeth are the same as those of the first embodiment, and the tilting angle and the axial position of the swing gear 4 are regulated through the meshing with the first gear 3 and the second gear 5. According to this embodiment, both of the first gear 3 and the second gear 5 are fixed to the casing 30. The tilting direction of the swing gear 4 is configured to be rotated by the input shaft 2. The profiles of the input shaft 2 and the tilting shaft 60 are the same as those of the second embodiment (refer to FIG. 6B).

Moreover, according to this embodiment, a constant velocity joint (joint mechanism) 9 and an output cup 56 are interposed between the swing gear 4 and the output shaft 50, and the revolution of the swing gear 4 is thus the rotation of the output shaft 50. The output shaft 50 is coupled to the output cup 56, and the output cup 56 is coupled to one side of the constant velocity joint 9. The output cup 56 is supported on the casing 30 so as to freely rotate by the bearing 51. The other side of the constant velocity joint 9 is coupled to the swing gear 4.

On this occasion, as the constant velocity joint 9, a constant velocity joint using balls and a retainer supported by an inner race on a spherical surface thereof, and having straight race surfaces formed on the inner and outer races is applied. This constant velocity joint 9 is variable in the axial position with respect to the outer race, eliminates an axial adjustment of the swing gear 4 and the output cup 56 at the time of assembly, and is thus particularly preferred for the present invention. On this occasion, a constant velocity joint variable in the axial position is applied as the constant velocity joint 9, but the constant velocity joint 9 is not limited to this type, and another type of constant velocity joint fixed in the axial position can be used as long as an adjustment is performed at the time of assembly.

Referring to FIG. 6A, a speed reduction operation to be carried out by the speed reduction apparatus 10 including the above-mentioned gear mechanism 11 is now described.

When the input shaft 2 rotates by one turn, the tilting shaft 60 rotates about the input rotational axis 70, and the swing gear 4 carries out the swing motion once about the reference point 72. On this occasion, the swing gear 4 revolves by an angle corresponding to the difference in the number of teeth between each of the first gear 3 and the second gear 5 and the swing gear 4. This revolution component rotates the output cup 56 through intermediation of the constant velocity joint 9. In other words, the configuration of this speed reduction apparatus 10 is a configuration of a single-stage differential gear. It is known that the speed reduction ratio of this speed reduction apparatus 10 can be calculated as 1/(Z1+1). For example, when Z1=49, a speed reduction ratio of 1/50 is provided. Thus, this speed reduction apparatus 10 is suitable for an application for a medium speed reduction ratio.

On this occasion, in FIG. 6A, when a clockwise load torque as viewed from the left side of the drawing sheet acts on the output cup 56, the swing gear 4 tends to rotate clockwise through intermediation of the constant velocity joint 9. Therefore, the first teeth 46 of the swing gear 4 push the first gear 3 downward in a phase on the near side of the drawing sheet, and the second teeth 47 push the second gear 5 upward in a phase on the far side of the drawing sheet. Thus, components of a reaction force acting on the swing gear 4 other than the components of rotating the tilting direction are canceled, and only a torque acts on the input shaft 2, whereas axial and eccentric forces do not act. Thus, highly efficient power transmission, low vibration, and low noise can be realized.

Note that, in this embodiment, the constant velocity joint 9 using the balls is applied as the joint mechanism for outputting the revolution component of the swing gear 4, but the joint mechanism is not limited to this type, and a joint of other type, such as a so-called gimbal mechanism or a spring coupling, may be applied.

Moreover, the various examples of the coupling unit 6 for the input shaft 2 and the tilting shaft 60 are described in the first to third embodiments described above, but the coupling unit 6 is not limited to these examples. For example, as illustrated in FIG. 6C, a plurality of steel balls 80 may be provided on the large diameter part 24 of the input shaft 2, and may be brought into rolling contact with an inner surface of the rectangular hole 64 of the tilting shaft 60. Moreover, as illustrated in FIGS. 6D and 6E, the coupling unit 6 may have a support hole 67 passing through the tilting shaft 60 in the axial direction, and a support shaft 27 configured to support the input shaft 2 passing through the support hole 67 so as to allow the tilting shaft 60 to freely swing about a direction orthogonal to the axial direction. Also in this case, the support shaft 27 is configured to restrict the relative rotation about the axial direction between the input shaft 2 passing through the support hole 67 and the tilting shaft while permitting the swing about the direction orthogonal to the axial direction. Note that, a relative position of the input shaft 2 and the tilting shaft 60 in the axial direction is regulated, and thus it is preferred that adjustment be carried out during the axial assembly of the input shaft 2 or a margin be secured in advance.

### Fourth Embodiment

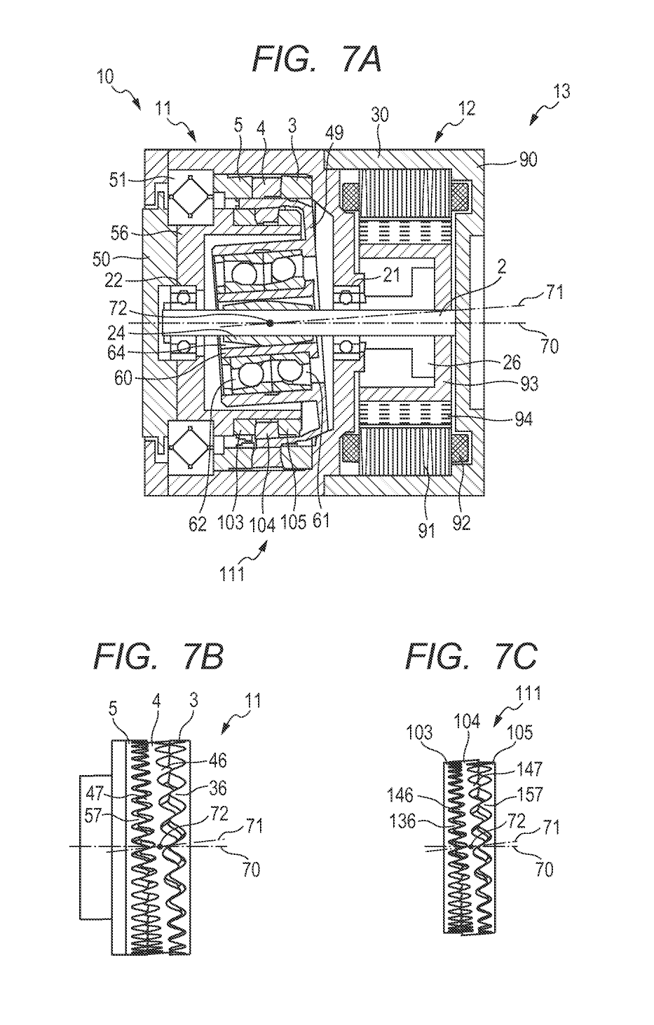

Referring to FIGS. 7A to 7C as well as FIG. 1, a robot apparatus 550 according to a fourth embodiment of the present invention is now described. In the robot apparatus 550 according to the fourth embodiment, a configuration of an actuator 13 including a speed reduction apparatus 10 is different from that according to the first embodiment. Therefore, in the fourth embodiment, the actuator 13 different from that according to the third embodiment is mainly described, and the same components as those of the third embodiment are denoted by the same reference symbols to omit a description thereof.

Referring to FIGS. 7A to 7C, the configuration of the actuator 13 according to the fourth embodiment is now described. As illustrated in FIG. 7A, the actuator 13 according to this embodiment includes the speed reduction apparatus 10 and a drive motor 12. Of these components, the speed reduction apparatus 10 is different from that according to the third embodiment in such a point that not a joint mechanism but a swing gear mechanism 111 is interposed between the output shaft 50 and the swing gear 4.

Also in this embodiment, similarly to the third embodiment, the numbers of the teeth of the first gear 3 and the second gear 5 are set to Z1, and the numbers of the first teeth 46 and the second teeth 47 of the swing gear 4 are set to Z1+1 (refer to FIG. 7B). According to this embodiment, the swing gear 4 is coupled to the respective bearings 61 and 62 through intermediation of a swing drum 49 having a substantially cylindrical profile. In other words, an inner peripheral surface of the swing drum 49 is fixed to outer peripheral surfaces of the respective bearings 61 and 62, and an outer peripheral surface of the swing drum 49 is fixed to an inner peripheral surface of the swing gear 4.

Moreover, according to this embodiment, the swing drum 49, the swing gear mechanism 111, and the output cup 56 are interposed between the swing gear 4 and the output shaft 5, and the revolution of the swing gear 4 is changed in speed by the swing gear mechanism 111 into the rotation of the output shaft 50. The swing gear 4 is coupled to the swing drum 49, and the swing drum 49 is coupled to the swing gear mechanism 111. The swing gear mechanism 111 is coupled to the output cup 56, and the output cup 56 is coupled to the output shaft.

As illustrated in FIG. 7C, the swing gear mechanism 111 includes a third gear 103, a fourth gear 105, and a small diameter swing gear (second swing gear) 104. The third gear 103 is fixed to the output cup 56 so as to be coaxial with the input rotational axis 70, and includes teeth 136 directed toward one side in the axial direction. The fourth gear 105 is fixed to the output cup 56 so as to be coaxial with the input rotational axis 70, and includes teeth 157 directed toward the third gear 103 side. The small diameter swing gear 104 is coaxial with the tilting rotational axis 71, and is fixed to an inner peripheral side of the swing drum 49 with respect to the swing gear 4 so as to rotate integrally therewith. The small diameter swing gear 104 includes third teeth 146 configured to obliquely mesh with the teeth 136 of the third gear 103 and fourth teeth 147 configured to obliquely mesh with the teeth 157 of the fourth gear 105.

According to this embodiment, the numbers of the teeth of the third gear 3 and the fourth gear 105 are set to Z2, and the numbers of the third teeth 146 and the fourth teeth 147 of the small diameter swing gear 104 are set to Z2+1. The tooth profile of these gears is also such a profile that a large number of teeth are simultaneously in contact with each other at the same tilting angle as the above-mentioned predetermined angle. Thus, the four gears, namely, the first gear 3, the second gear 5, the third gear 103, and the fourth gear 105 smoothly mesh with the swing gear 4 and the small diameter swing gear 104 under a state in which all the four gears are coaxial with the input shaft 2. Note that, the tilting angles of the swing gear 4 and the small diameter swing gear 104 are determined by the first gear 3 and the second gear 5, and hence the operation is possible even without the fourth gear 105.

On the other hand, the input shaft 2 is directly coupled to the drive motor 12. The drive motor 12 includes a motor case 90, a stator yoke 91 fixed to the motor case 90, a coil 92 provided on the stator yoke, a rotor yoke 93 provided on the input shaft 2 and an annular seat 26, and a magnet 94. The drive motor 12 constructs a brushless motor of an inner rotor type.

Referring to FIG. 7A, an operation of the above-mentioned actuator 13 is now described. Note that, a speed reduction operation of the speed reduction apparatus 10 is the same as the speed reduction operation of the first embodiment, and a detailed description thereof is therefore omitted.

The load states of the respective components when the load torque acts on the output shaft 50 are different from those of the first embodiment. In FIG. 7A, when a clockwise load torque as viewed from the left side of the drawing sheet acts on the third gear 103 and the fourth gear 105, a force of the teeth 136 of the third gear 103 for pushing the third teeth 146 of the small diameter swing gear 104 downward acts in the phase on the near side of the drawing sheet. Simultaneously, a force of the teeth 157 of the fourth gear 105 for pushing the fourth teeth 147 of the small diameter swing gear 104 upward acts in the phase on the far side of the drawing sheet. Further, the first teeth 46 of the swing gear 4 push the first gear 3 downward in the phase on the near side of the drawing sheet, and the second teeth 47 push the second gear 5 upward in the phase on the far side of the drawing sheet.

Thus, as in the third embodiment, components of a reaction force acting on the swing gear 4 and the small diameter swing gear 104 other than the components of rotating the tilting direction are canceled, and only a torque acts on the input shaft 2, whereas axial and eccentric forces do not act. In addition, according to this embodiment, the forces acting on the output shaft 50 and the bearing 51 for the output cup 56 are also canceled, and thus become very small. Therefore, highly efficient power transmission, low vibration, and low noise can be realized. Thus, according to this embodiment, while a large number of gears are used, all the gears share the load on a large number of teeth in a balanced manner, and hence the speed reduction apparatus 10, which is compact in size, high in load capacity, high in rigidity, and high in efficiency, can be realized.

As described above, in the actuator 13 according to this embodiment, the speed reduction apparatus 10, which is compact in size, high in load capacity, high in rigidity, and high in efficiency, and the drive motor 12 are integrated with each other, and hence the actuator 13 compact in size and high in performance can be provided. Moreover, the case in which a six-axis vertical articulated robot arm is applied as the robot arm 501 is described, but the robot arm is not limited to this example. For example, a five-axis or seven-axis robot, a SCARA robot, an orthogonal robot, and a robot other than an articulated robot may be applied. Further, the performance of the robot arm 501 can be increased by using the actuators 13 for the joints 511 to 516 of the robot arm 501. Moreover, the present invention is suitable not only for the robot arm 501, but also for other applications requiring a small size and a high torque, such as a drive of an electric vehicle and a belt conveyer.

Moreover, the torque can be shared among a large number of teeth in the speed reduction apparatus 10 according to the first to fourth embodiments described above, and hence the speed reduction apparatus 10 very high in performance can be realized with use of, for example, high performance steel as the gear material. Note that, general low-cost steel may be used as the gear material, and a nonferrous metal, a sintered material, a resin, and the like may also be applied.

Note that, according to this embodiment, the brushless motor of the inner rotor type is applied as the drive motor 12, but the motor 12 is not limited to this type, and other types such as an outer rotor type and a coreless motor may be applied as the drive motor 12.

Moreover, the actuator 13 constructed by integrating the speed reduction apparatus 10 and the drive motor 12 with each other according to this embodiment may be similarly applied to the other embodiments described above, and an actuator compact in size and high in performance due to large torque can be realized through the application of the present invention. Further, the actuator may be constructed so that transmission members such as a belt and a pulley are used for the input shaft 2 of the speed reduction apparatus 10 and an independent motor is used for the drive. In this case, a combination with more types of motor is facilitated than in the case of integrating the components.

Moreover, according to the first to fourth embodiments described above, the speed reduction apparatus includes one unit of the gear mechanism 11, but the number of the gear mechanisms 11 is not limited to one, and the speed reduction apparatus 10 may include a plurality of the gear mechanisms 11.

Moreover, the tooth profile described above in the first to fourth embodiments, in which the contact occurs over substantially the entire circumference, is an example, and the tooth profile is not limited to this example. For example, in order to separate a vicinity of the passing-by position that does not contribute to the torque transmission due to a large pressure angle and a vicinity of the most deeply meshing position, the distal end part of the tooth tip and the most recessed part of the tooth base may be ground off. Alternatively, the distal end part of one tooth is formed into an arc having a constant radius, and a curve acquired as a circumscribed line (profile conforming to a passed area) of a trajectory of the distal end part moving around the mating tooth is set as the profile of the mating tooth. Then, a curve acquired as a circumscribed line of a trajectory of the distal end part of the mating tooth having the acquired profile, which moves around the tooth in the arc profile, may be set as the profile of the tooth having the distal end part in the arc profile.

According to the present invention, the tilting angle and the axial position of the swing gear are regulated by the two gears, namely, the first gear and the second gear, and the tilting direction is regulated by the tilting shaft. As a result, the first shaft and the tilting shaft do not need to be integrated with each other, thereby being capable of facilitating component machining. Moreover, the load torque can be shared among a large number of teeth, and hence a high assembly property, a high rigidity, and a high load capacity can be realized without increasing the size.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-014566, filed Jan. 29, 2014, which is hereby incorporated by reference herein in its entirety.

What is claimed is:

1. A gear mechanism, comprising:
a first gear comprising teeth directed toward one side in an axial direction, and being fixed to a casing;
a second gear comprising teeth opposed to the teeth of the first gear, and being provided coaxially with the first gear;
a first shaft provided coaxially with the first gear and the second gear in a freely rotatable manner;
a tilting shaft provided so as to be tilted with respect to the first shaft;
a first swing gear arranged between the first gear and the second gear, and provided so as to freely rotate about the tilting shaft,
first swing gear comprising:
first teeth different in number by one tooth from the teeth of the first gear, and configured to mesh with the teeth of the first gear; and
second teeth different in number by one tooth from the teeth of the second gear, and configured to mesh with the teeth of the second gear on an opposite side of a meshing portion of the first teeth with the teeth of the first gear in a radial direction and in the axial direction,
first swing gear being configured to mesh with the first gear and the second gear at a certain tilting angle;
a second shaft provided coaxially with the first shaft, and configured to rotate integrally with any one of the second gear and the first swing gear; and
a coupling unit configured to couple the first shaft and the tilting shaft to each other so as to prevent relative rotation between the first shaft and the tilting shaft, and to allow the tilting shaft to freely swing about a center part between the first gear and the second gear in a plane including a center axis of the first shaft.

2. A gear mechanism according to claim 1, further comprising a support unit configured to support the first swing gear in the radial direction with respect to at least one of the first gear or the second gear.

3. A gear mechanism according to claim 2, wherein a contact surface between the first swing gear and the support unit is shaped so that the first swing gear and the support unit are brought into contact with each other at a portion without relative speed.

4. A gear mechanism according to claim 1, wherein the second shaft rotates integrally with the second gear.

5. A gear mechanism according to claim 1, wherein:
the second shaft rotates integrally with the first swing gear; and
the second gear is fixed to the casing, and is equal in number of teeth to the first gear.

6. A gear mechanism according to claim 5, wherein the second shaft and the first swing gear are coupled to each other by a joint mechanism.

7. A gear mechanism according to claim 5, wherein the second shaft and the first swing gear are coupled to each other by a swing gear mechanism comprising:
a third gear being coaxially coupled to the second shaft, and comprising teeth directed toward one side in the axial direction; and
a second swing gear comprising third teeth different in number by one tooth from the teeth of the third gear and configured to obliquely mesh with the teeth of the third gear, and being rotatable coaxially and integrally with the first swing gear.

8. A gear mechanism according to claim 1, wherein the coupling unit comprises:
a support hole passing through the tilting shaft in the axial direction; and
a support shaft configured to support the first shaft passing through the support hole so as to allow the tilting shaft to freely swing about a direction orthogonal to the axial direction.

9. A gear mechanism according to claim 1, wherein the coupling unit comprises:
a support hole passing through the tilting shaft in the axial direction; and
a rotation restriction part configured to restrict relative rotation about the axial direction between the first shaft passing through the support hole and the tilting shaft while permitting swing about a direction orthogonal to the axial direction.

10. A speed change apparatus, comprising at least one unit of the gear mechanism of claim 1,
the speed change apparatus being configured to change a speed of rotation input on one of the first shaft and the second shaft, and to output the rotation changed in speed from another of the first shaft and the second shaft.

11. An actuator, comprising:
a drive motor; and
the speed change apparatus of claim 10, which has the one of the first shaft and the second shaft coupled to an output shaft of the drive motor.

12. An articulated robot arm, comprising:
a plurality of joints configured to couple a plurality of links to each other; and
the actuator of claim 11, which is provided on at least one of the plurality of joints.
